(19) United States
(12) Patent Application Publication
(10) Pub. No.: US 2020/0221848 A1
(43) Pub. Date: Jul. 16, 2020

(54) COMB WITH MAGNIFYING LENS

(71) Applicant: Dejuan Morceil Withers, Louisville, KY (US)

(72) Inventor: Dejuan Morceil Withers, Louisville, KY (US)

(21) Appl. No.: 16/730,224

(22) Filed: Dec. 30, 2019

Related U.S. Application Data
(60) Provisional application No. 62/790,608, filed on Jan. 10, 2019.

(51) Int. Cl. A45D 24/10; G02B 25/00

(52) U.S. Cl. CPC A45D 24/10; A45D 2024/002; G02B 25/002

(57) ABSTRACT

A comb includes a handle and a body extending from the handle. A plurality of coplanar teeth extend perpendicular from a side of the body. A magnifying lens is coupled to the body. The magnifying lens is a convex lens that produces a magnified image of an object. A barber or hair stylist may use the magnifying lens to magnify hair follicles, allowing the barber or hair stylist to cut the hair more precisely.

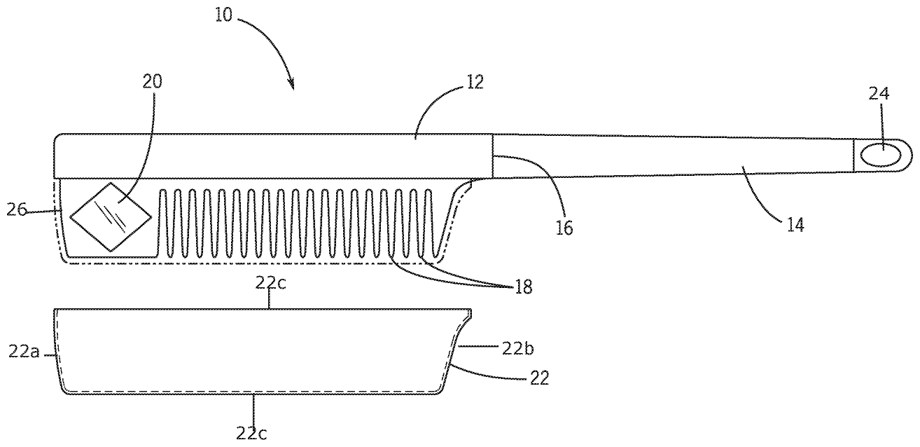

### CROSS-REFERENCE TO RELATED APPLICATION

This application claims the benefit of priority of U.S. provisional application No. 62/790,608, filed Jan. 10, 2019, the contents of which are herein incorporated by reference.

### BACKGROUND OF THE INVENTION

The present invention relates to cutting hair and, more particularly, to a comb with a magnifying lens.

A comb is a tool consisting of a shaft that holds a row of teeth for pulling through the hair to clean, untangle, or style it. Combs are also used during the process of cutting hair. For example, a barber combs the hair such that ends of the hair are sticking above the teeth and then clips the hair in an even fashion.

A Shape-Up, also called a Line-Up or an Edge-up, is a hairstyle that involves cutting along the natural hairline to make it straight. Shape-ups or edge-ups are basically the fundamental outline for haircuts today. Using a magnifying lens can help the barber more accurately cut along the natural hairline.

As can be seen, there is a need for a handy barber tool that has a magnifying lens.

### SUMMARY OF THE INVENTION

In one aspect of the present invention, a comb comprises: a handle; a body extending from the handle; a plurality of coplanar teeth extending perpendicular from a side of the body; and a magnifying lens coupled to the body.

In another aspect of the present invention, a comb comprises: a handle; a body comprising a proximal end extending from the handle and a distal end; a plurality of coplanar teeth extending perpendicular from a side of the body; a tab extending perpendicular from the side of the body at the distal end, the tab being coplanar with the plurality of coplanar teeth, and the tab comprising an opening defined therethrough; and a magnifying lens coupled to the tab within the opening.

These and other features, aspects and advantages of the present invention will become better understood with reference to the following drawings, description and claims.

### BRIEF DESCRIPTION OF THE DRAWINGS

The FIGURE includes an exploded view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Referring to the FIGURE, the present invention includes a comb 10. The comb 10 includes a handle 14 and a body 12 extending from the handle 14. A plurality of coplanar teeth 18 extend perpendicular from a side of the body 12. A magnifying lens 20 is coupled to the body 12. The magnifying lens 20 is a convex lens that produces a magnified image of an object. A barber or hair stylist may use the magnifying lens 20 to magnify hair follicles, allowing the barber or hair stylist to cut the hair more precisely.

The body 12 and the handle 14 define an elongated rod. The handle includes a proximal and a distal end and the body 12 includes a proximal and a distal end. The proximal ends of the handle 14 and the body 12 are joined together so that the body 12 and the handle 14 share a common longitudinal axis. A handle opening 26 may be defined on a distal end of the handle 14 so that a user may easily hang the comb 10 from a hook for storage.

In certain embodiments, the body 12 and handle 14 are rotabably coupled together by a rotating joint 16. The rotating joint 16 allows the body 12 and handle 14 to rotate about the longitudinal axis independently and relative to one another. The rotating joint 16 may include a ball and sock joint, internal ridges and slots, or other type of pivoting joint.

The plurality of coplanar teeth 18 define the comb portion of the comb 10. The plurality of coplanar teeth 18 are substantially parallel and extend from the same side of the body 12 in a same direction. In certain embodiments, a tab 24 extends perpendicular from the same side of the body 12 as the plurality of coplanar teeth 18. In certain embodiments, the tab 24 may be at or near the distal end of the body 12. The tab 24 may also be coplanar with the plurality of coplanar teeth 18. The tab 24 includes an inner edge that defines a tab opening therethrough. The magnifying lens 20 is coupled to the inner edge of the tab 24 within the opening.

The present invention may further include a sheath 22 for protecting the plurality of coplanar teeth 18 and the magnifying lens 20. The sheath includes elongated sidewalls joined together along front edges 22a, rear edges 22b, and bottom edges 22c. Top edges 22c are separate defining an opening into the sheath 22. The sheath 22 releasably attaches to the body 12 and covers the plurality of coplanar teeth 18 and the tab 24.

It should be understood, of course, that the foregoing relates to exemplary embodiments of the invention and that modifications may be made without departing from the spirit and scope of the invention as set forth in the following claims.

What is claimed is:

1. A comb comprising:
a handle;
a body extending from the handle;
a plurality of coplanar teeth extending perpendicular from a side of the body; and
a magnifying lens coupled to the body.

2. The comb of claim 1, wherein the body comprises a proximal end joined with the handle and a distal end.

3. The comb of claim 2, further comprising a tab extending perpendicular from the side of the body at the distal end, wherein the tab comprises a tab opening defined therethrough, and the magnifying lens is coupled to the tab within the opening.

4. The comb of claim 3, wherein the tab is coplanar with the plurality of coplanar teeth.

5. The comb of claim 4, further comprising a sheath comprising elongated sidewalls joined together along front edges, rear edges, and bottom edges, wherein top edges are separate defining an opening into the sheath, wherein the sheath releasably attaches to the body and covers the plurality of coplanar teeth and the tab.

6. The comb of claim 1, wherein the handle is an elongated rod comprising a proximal end joined to the body and a distal end.

7. The comb of claim 6, wherein a handle opening is defined at the distal end of the handle.

8. The comb of claim 1, wherein the body and the handle share a longitudinal axis.

9. The comb of claim 8, wherein the body and handle are rotabably coupled together and are capable of rotating about the longitudinal axis independently and relative to one another.

10. A comb comprising:
a handle;
a body comprising a proximal end extending from the handle and a distal end;
a plurality of coplanar teeth extending perpendicular from a side of the body;
a tab extending perpendicular from the side of the body at the distal end, the tab being coplanar with the plurality of coplanar teeth, and the tab comprising an opening defined therethrough; and
a magnifying lens coupled to the tab within the opening.

11. The comb of claim 10, further comprising a sheath comprising elongated sidewalls joined together along front edges, rear edges, and bottom edges, wherein top edges are separate defining an opening into the sheath, wherein the sheath releasably attaches to the body and covers the plurality of coplanar teeth and the tab.

12. The comb of claim 10, wherein the handle is an elongated rod comprising a proximal end joined to the body and a distal end, wherein a handle opening is defined at the distal end of the handle.

13. The comb of claim 10, wherein the body and the handle share a longitudinal axis.

14. The comb of claim 10, wherein the body and handle are rotabably coupled together and are capable of rotating about the longitudinal axis independently and relative to one another.
